(19) United States
(12) Patent Application Publication
(10) Pub. No.: US 2026/0178952 A1
(43) Pub. Date: Jun. 25, 2026

(54) ADAPTIVE CONTROL APPARATUS FOR QUANTUM COMPUTING SYSTEM

(71) Applicant: NATIONAL CHENGCHI UNIVERSITY, Taipei City (TW)

(72) Inventors: Hsiu-Chuan HSU, Taipei City (TW); Che-Pin CHEN, Taipei City (TW)

(21) Appl. No.: 19/095,602

(22) Filed: Mar. 31, 2025

(30) Foreign Application Priority Data
Apr. 10, 2024 (TW) 113113443
Mar. 17, 2025 (TW) 114109933

(51) Int. Cl. G06N 10/40; G06N 10/20; G06N 10/70

(52) U.S. Cl. CPC G06N 10/40; G06N 10/20; G06N 10/70

(57) ABSTRACT

An adaptive control apparatus includes a quantum circuit information processing unit, a quantum computing quality evaluation unit, and an adaptive control unit. The quantum circuit information processing unit transmits quantum circuit information into a quantum computing unit, so that the quantum computing unit performs a computation according to the quantum circuit information. The quantum computing quality evaluation unit receives measurement information of one or more qubits of the quantum computing unit and performs error rate calculation according to the measurement information to generate an error rate. The adaptive control unit receives the error rate from the quantum computing quality evaluation unit. When the error rate is greater than an error rate threshold, the adaptive control unit generates one or more pulse adjustment parameters, and a pulse generation unit generates a pulse signal according to the pulse adjustment parameters and transmits the pulse signal to the quantum computing unit.

### CROSS REFERENCE TO RELATED APPLICATIONS

This Non-provisional application claims priority under 35 U.S.C. § 119(a) on Patent Application No(s). 113113443 filed in Taiwan, Republic of China on Apr. 10, 2024, and 114109933 filed in Taiwan, Republic of China on Mar. 17, 2025, the entire contents of which are hereby incorporated by reference.

### BACKGROUND

### Technology Field

The present disclosure relates to an adaptive control apparatus and, in particular, to an adaptive control apparatus applied to the quantum computing system.

### Description of Related Art

The development of quantum computing technology stems from the comprehensive exploration of the principles of quantum mechanics and has rapidly become an important subject in future computing technology. Unlike traditional computers, quantum computers use qubits (quantum bits) to perform calculations. These qubits can be in a superposition state of 0 and 1 at the same time, and achieve high-speed computing through quantum entanglement or quantum superposition. Early quantum computing theories were proposed by theorists, such as Richard Feynman and Peter Shor, while today's quantum computing has attracted much industry's attention. The key players devoted in developing the quantum technology include IBM, Google, Microsoft and IonQ.

Currently, quantum computing platforms mainly include superconducting qubits, trapped ion qubits and photonic quantum computing. Although quantum computers at this stage still face many challenges, such as decoherence and error rate, with the advancement of quantum error correction and enhancing the quality of manufacturing processes, scientists are gradually improving the availability and stability of quantum computing.

Quantum superposition is one of the core concepts of quantum computing. It refers to the linear combinations of the states of 0 and 1 at the same time. This allows quantum computers to perform multiple calculations in parallel when processing information, thereby demonstrating more powerful computing capabilities than traditional classical computers on certain specific problems. For example, in factorization, quantum simulation and optimization problems, quantum computing can significantly improve computing efficiency. However, in reality, since the quantum superposition state is extremely fragile and is easy collapsed due to environmental noise, the error rate of quantum computers is relatively high. In order to overcome this problem, researchers are committed to developing quantum error correction codes and relevant technology for reducing the impact of external noise on the calculation results. In addition, the hardware implementation of quantum computing still faces challenges, such as how to increase number of qubits and maintain their coherence. These problems limit the scalability of current quantum computers, making it difficult to process larger-scale computing tasks.

As mentioned above, the quantum computing system is very susceptible to interference from the external environment (environmental noise), such as temperature changes, electromagnetic field fluctuations, vacuum levels, or ambient air pressure. These interferences may cause decoherence in the quantum states, causing the original superposition state thereof to quickly disappear and become a definite classical state (0 or 1). This phenomenon can lead to calculation errors. Therefore, how to accurately control the quantum system and reduce environmental noise are a major challenge in quantum computing technology.

The conventional quantum computing systems mainly use pulse control technology to adjust the quantum unitary evolution to generate the target quantum state. However, quantum states are still susceptible to interference due to the influence of environmental noise and quantum decoherence, leading to calculation errors. Currently, the effective methods to reduce environmental noise include dynamical decoupling (DD) and optimal quantum control, both of which achieve more accurate quantum computing results by controlling pulse waves. Therefore, it is desired to provide a stable pulse wave control technology that can mitigate the influence of environmental noise to the quantum computing system.

### SUMMARY

In view of the foregoing, an objective of this disclosure is to provide an adaptive control apparatus that can utilize a stable pulse wave control technology to improve the availability and stability of the quantum computing system.

To achieve the above, an adaptive control apparatus of this disclosure, which is applied to a quantum computing system, includes a quantum circuit information processing unit, a quantum computing quality evaluation unit, and an adaptive control unit. The quantum computing system includes a quantum computing unit and a pulse generation unit. The quantum circuit information processing unit transmits quantum circuit information into the quantum computing unit, and the quantum computing unit performs a computation according to the quantum circuit information. The quantum computing quality evaluation unit receives the measurement information of one or more qubits of the quantum computing unit and performs an error rate calculation according to the measurement information of the qubits to generate an error rate. The adaptive control unit receives the error rate generated by the quantum computing quality evaluation unit. When the error rate is greater than an error rate threshold, the adaptive control unit generates one or more pulse adjustment parameters, and the pulse generation unit generates a pulse signal according to the pulse adjustment parameters and transmits the pulse signal to the quantum computing unit.

In one embodiment, the error rate threshold is less than 0.2.

In one embodiment, the adaptive control apparatus further includes a pulse adjustment parameter inputting unit, which includes a pulse adjustment parameter inputting interface configured for manually feeding in one or more fluctuation parameters, and the adaptive control unit regenerates other pulse adjustment parameters according to the fluctuation parameters. The fluctuation parameters can be manually controlled.

In one embodiment, the pulse adjustment parameters include an amplitude parameter, a phase parameter, a frequency parameter, or a period parameter.

In one embodiment, the fluctuation parameters include an amplitude fluctuation parameter, a phase fluctuation parameter, a frequency fluctuation parameter, or a period fluctuation parameter.

In one embodiment, the pulse signal generated by the pulse generation unit is a microwave pulse signal or a laser pulse signal.

In one embodiment, when the error rate is less than the error rate threshold, the adaptive control unit does not adjust the pulse adjustment parameters.

In one embodiment, when the pulse adjustment parameters include the amplitude parameter, the adaptive control unit increases or decreases the amplitude parameter by an amplitude variation to generate other pulse adjustment parameters.

In one embodiment, when the pulse adjustment parameters include the phase parameter, the adaptive control unit increases or decreases the phase parameter by a phase variation to generate other pulse adjustment parameters.

In one embodiment, when the pulse adjustment parameters include the frequency parameter, the adaptive control unit increases or decreases the frequency parameter by a frequency variation to generate other pulse adjustment parameters.

In one embodiment, when the pulse adjustment parameters include the period parameter, the adaptive control unit increases or decreases the period parameter by a period variation to generate other pulse adjustment parameters.

As mentioned above, the quantum computing quality evaluation unit can generate an error rate E₀, so that the adaptive control apparatus of this disclosure can generate, according to the error rate E₀, one or more pulse adjustment parameters for controlling the quantum state and the evolution speed, as well as whether to resonate with the energy level of qubits. Then, the adaptive control apparatus can generate a precise pulse signal according to the pulse adjustment parameters. Accordingly, the adaptive control device of the present disclosure can improve the availability and stability of the quantum computing system.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic block diagram showing an adaptive control device according to an embodiment of the present disclosure, which is applied to a quantum computing system; and

FIG. 2 is a schematic block diagram showing an adaptive control device according to another embodiment of the present disclosure, which is applied to a quantum computing system.

### DETAILED DESCRIPTION OF THE DISCLOSURE

The present disclosure will be apparent from the following detailed description, which proceeds with reference to the accompanying drawings, wherein the same references relate to the same elements.

To be noted, the quantum computing system of the embodiments may include a quantum computing unit (or a quantum IC) and a pulse generation unit.

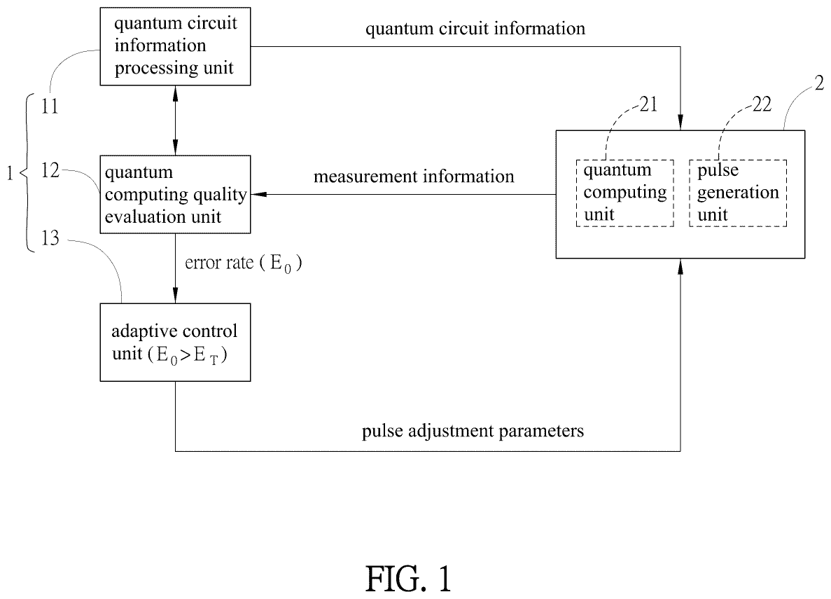

Referring to FIG. 1, an adaptive control apparatus 1 of this embodiment can be applied to a quantum computing system 2. The quantum computing system 2 includes a quantum computing unit 21 and a pulse generation unit 22, and the adaptive control apparatus 1 includes a quantum circuit information processing unit 11, a quantum computing quality evaluation unit 12, and an adaptive control unit 13.

The quantum circuit information processing unit 11 can transmit the quantum circuit information into the quantum computing system 2, and the quantum computing unit 21 performs a computation according to the quantum circuit information and the pulse signal generated by the pulse generation unit 22. The quantum computing quality evaluation unit 12 receives the measurement information of one or more qubits of the quantum computing unit 21 and performs an error rate calculation according to the measurement information of the qubits to generate an error rate E₀. The error rate E₀ can be calculated based on the following equation:

$${E}_{0} = 1 - \sqrt{\frac{{2}^{{N}_{0}} {P}_{1} - 1}{{2}^{{N}_{0}} {P}_{0} - 1}}$$

The calculation method of the error rate E₀ has been disclosed in Taiwan Patent Application No. 112112443, and the detailed description thereof will be omitted here.

The adaptive control unit 13 receives the error rate E₀ generated by the quantum computing quality evaluation unit 12. When the error rate E₀ is greater than an error rate threshold E_{T}, the adaptive control unit 13 generates one or more pulse adjustment parameters. To be noted, in this embodiment, the error rate threshold E_{T} represents a value that a user can tolerate for the error rate, such as a value less than 0.2. The pulse adjustment parameters include at least one of an amplitude parameter, a phase parameter, a frequency parameter, and a period parameter. In one embodiment, the adaptive control unit 13 may generate one or more pulse adjustment parameters. In other words, the pulse adjustment parameters may include a combination of any two of the aforementioned parameters, or a combination of any three or four of the aforementioned parameters. The pulse adjustment parameters are configured for changing the pulse signal generated by the pulse generation unit 22.

The control operation of the adaptive control unit 13 of the present disclosure with using a microwave pulse signal will be described hereinafter.

A controllable square microwave pulse signal can be expressed as:

$$S ( t ) = A ( t ) \cdot rect ( \frac{t - nT}{τ} ) \cdot cos ( 2 π {f}_{c} + ∅ ( t ) )$$

Wherein, A(t) is an amplitude modulation function, which can vary with time t, rect(x) is a square wave pulse envelope function, T is a pulse period, n is a positive integer, nT is the time point representing the center of the nth square wave, σ is the pulse width, f_{c} is the carrier frequency, and Ø(t) is a phase modulation function.

According to the equation of square microwave pulse signal shown above, as long as the pulse parameters (A, Ø, T, f_{c}) are adjusted appropriately, a specific pulse signal can be generated for controlling the quantum state of the qubits to reach the target state. In other words, as long as the pulse adjustment is accurate, the quantum gates, such as Pauli-X gate, Pauli-Y gate, Hadamard gate and/or CNOT gate, can be implemented. In this embodiment, when the error rate E₀ is greater than the error rate threshold E_{T}, the adaptive control unit 13 can generate at least one of the pulse adjustment parameters for adjusting any one of the four parameters (A, Ø, T, f_{c}). For example, within a time interval Δt, and n»[Δt/T+τ], if the generated pulse adjustment parameters are provided to decrease the parameter T, the number of pulses will increase. Conversely, if the generated pulse adjustment parameters are provided to increase the parameter T, the number of pulses will decrease. The next adjustment to decrease the parameter T or increase the parameter T depends on the following error rate after the previous adjustment. For example, after the previous adjustment, the quantum computing quality evaluation unit 12 can receive the measurement information of the qubits of the quantum computing unit 21 again, and performs the error rate calculation based on the measurement information of the qubits to obtain another error rate E₁ (the error rate after the previous adjustment). This adjustment process can be repeatedly performed until the error rate E₁ is less than the error rate threshold E_{T}.

To be noted, the adjustment method for other parameters is roughly the same as that for adjusting the parameter T. For example, in the case of adjusting the phase parameter Ø, when the phase parameter Ø is adjusted (increased) to Ø+Δφ, and the error rate E₁ (the error rate after the adjustment) is greater than the original error rate Eₒ, the phase parameter will be adjusted to Ø−Δφ for the next adjustment. Then, when the error rate E₁ (the error rate after the next adjustment) is less than the original error rate Eₒ, the phase parameter will be further adjusted to Ø−2Δφ for the next adjustment. This adjustment process can be repeatedly performed until the error rate E₁ is less than the error rate threshold E_{T}. In brief, in this embodiment, the pulse adjustment parameters are the phase adjustment parameters (Ø+Δφ; Ø−Δφ) obtained by increasing or decreasing the phase parameter by a phase variation, and when the error rate E₁ after adjustment is less than the error rate Eₒ before adjustment, the phase adjustment parameters continue to be adjusted by decreasing to (Ø−2Δφ). To be noted, other parameter adjustments can be made in the same way. In addition, it should be particularly noted that the aforementioned symbol “Δ” represents a variation in any parameter.

As mentioned above, in this embodiment, when the pulse adjustment parameters include the phase parameter, the adaptive control unit increases or decreases the phase parameter by a phase variation to generate other pulse adjustment parameters. In one embodiment, when the pulse adjustment parameters include the amplitude parameter, the adaptive control unit increases or decreases the amplitude parameter by an amplitude variation to generate other pulse adjustment parameters. In one embodiment, when the pulse adjustment parameters include the frequency parameter, the adaptive control unit increases or decreases the frequency parameter by a frequency variation to generate other pulse adjustment parameters. In one embodiment, when the pulse adjustment parameters include the period parameter, the adaptive control unit increases or decreases the period parameter by a period variation to generate other pulse adjustment parameters.

To be noted, the adaptive control unit 13 of this embodiment may generate two or more pulse adjustment parameters, such as a pulse adjustment parameter for adjusting the amplitude parameter A and a pulse adjustment parameter for adjusting the phase parameter Ø. In this case, the adaptive control unit 13 controls the quantum state and its evolution process. In addition, the adjustment method for other square pulse signals (e.g. the square laser pulse signals) is the same.

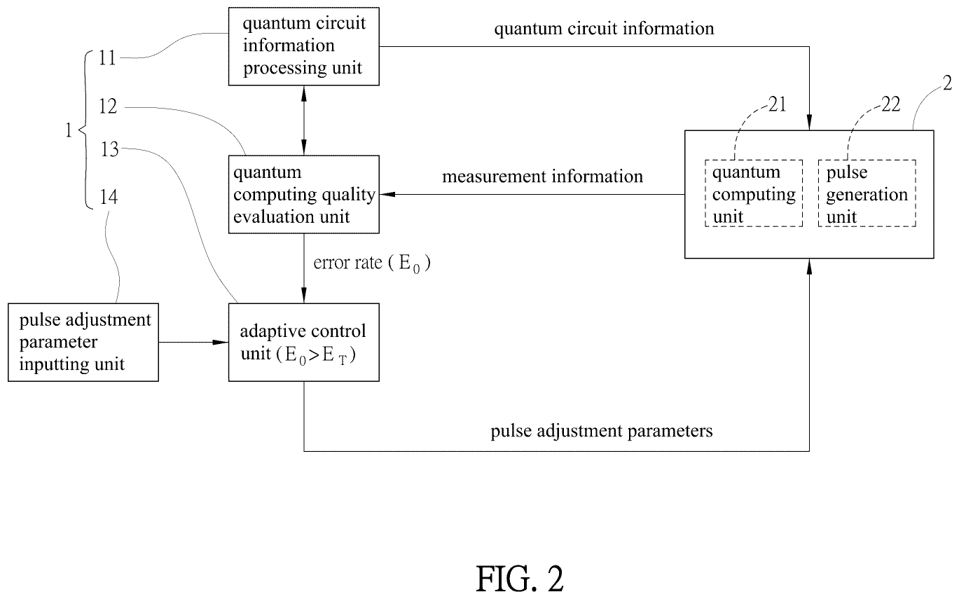

Referring to FIG. 2, the adaptive control device 1 according to another embodiment of this disclosure may further include a pulse adjustment parameter inputting unit 14, which includes a pulse adjustment parameter inputting interface (not shown) configured for manually feeding in one or more fluctuation parameters, and the adaptive control unit 13 regenerates updated pulse adjustment parameters according to the fluctuation parameters. For example, when the adaptive control unit 13 decreases the period T, but the error rate E₀ becomes larger, the user can manually input a larger period T or period variation ΔT by using the pulse adjustment parameter inputting interface, thereby changing the fluctuation of the original pulse adjustment parameters with the increased period parameter T to decrease the error rate E₀. To be noted, in this embodiment, the fluctuation parameters are not limited to increase or decrease the pulse adjustment parameters generated by the adaptive control unit 13. In some cases, the manually controlled fluctuation parameters can be used to accelerate the increasing or decreasing speed of the original pulse adjustment parameters, thereby accelerating the process of decreasing of the error rate E₀.

In this embodiment, the fluctuation parameters may include at least one of an amplitude fluctuation parameter, a phase fluctuation parameter, a frequency fluctuation parameter, and a period fluctuation parameter.

As shown in FIG. 2, the adaptive control device 1 of the present disclosure can be applied to a quantum computing system 2, thereby forming a quantum computing system with adaptive control function. In other words, in practical applications, the adaptive control device 1 and the quantum computing system 2 can be integrated to form a more complete quantum computing system.

In summary, the quantum computing quality evaluation unit can generate an error rate E₀, so that the adaptive control apparatus of this disclosure can generate, according to the error rate E₀, one or more pulse adjustment parameters for controlling the quantum state and the evolution speed, as well as whether to resonate with the energy level of qubits. Then, the adaptive control apparatus can generate a precise pulse signal according to the pulse adjustment parameters. Accordingly, the adaptive control device of the present disclosure can improve the availability and stability of the quantum computing system.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An adaptive control apparatus, which is applied to a quantum computing system, wherein the quantum computing system comprises a quantum computing unit and a pulse generation unit, the adaptive control apparatus comprising:
a quantum circuit information processing unit transmitting quantum circuit information into the quantum computing unit, wherein the quantum computing unit performs a computation according to the quantum circuit information;
a quantum computing quality evaluation unit receiving measurement information of one or more qubits of the quantum computing unit and performing an error rate calculation according to the measurement information of the qubits to generate an error rate; and
an adaptive control unit receiving the error rate generated by the quantum computing quality evaluation unit, wherein when the error rate is greater than an error rate threshold, the adaptive control unit generates one or more pulse adjustment parameters, and the pulse generation unit generates a pulse signal according to the pulse adjustment parameters and transmits the pulse signal to the quantum computing unit.

2. The adaptive control apparatus of claim 1, wherein the error rate threshold is less than 0.2.

3. The adaptive control apparatus of claim 1, further comprising:
a pulse adjustment parameter inputting unit comprising a pulse adjustment parameter inputting interface configured for manually feeding in one or more fluctuation parameters, wherein the adaptive control unit regenerates other pulse adjustment parameters according to the fluctuation parameters.

4. The adaptive control apparatus of claim 1, wherein the pulse adjustment parameters comprise an amplitude parameter, a phase parameter, a frequency parameter, or a period parameter.

5. The adaptive control apparatus of claim 3, wherein the fluctuation parameters comprise an amplitude fluctuation parameter, a phase fluctuation parameter, a frequency fluctuation parameter, or a period fluctuation parameter.

6. The adaptive control apparatus of claim 1, wherein the pulse signal generated by the pulse generation unit is a microwave pulse signal or a laser pulse signal.

7. The adaptive control apparatus of claim 1, wherein when the error rate is less than the error rate threshold, the adaptive control unit does not change the pulse adjustment parameters.

8. The adaptive control apparatus of claim 4, wherein when the pulse adjustment parameters comprise the amplitude parameter, the adaptive control unit increases or decreases the amplitude parameter by an amplitude variation to generate other pulse adjustment parameters.

9. The adaptive control apparatus of claim 4, wherein when the pulse adjustment parameters comprise the phase parameter, the adaptive control unit increases or decreases the phase parameter by a phase variation to generate other pulse adjustment parameters.

10. The adaptive control apparatus of claim 4, wherein when the pulse adjustment parameters comprise the frequency parameter, the adaptive control unit increases or decreases the frequency parameter by a frequency variation to generate other pulse adjustment parameters.

11. The adaptive control apparatus of claim 4, wherein when the pulse adjustment parameters comprise the period parameter, the adaptive control unit increases or decreases the period parameter by a period variation to generate other pulse adjustment parameters.
